(19) United States
(12) Patent Application Publication
(10) Pub. No.: US 2007/0234015 A1
(43) Pub. Date: Oct. 4, 2007

(54) APPARATUS AND METHOD OF PROVIDING FLEXIBLE LOAD AND STORE FOR MULTIMEDIA APPLICATIONS

(76) Inventors: Tien-Fu Chen, Min-Hsiung (TW); Chih-Heng Kang, Min-Hsiung (TW); Shu-Hsuan Chou, Min-Hsiung (TW)

Correspondence Address: SINORICA, LLC, 528 FALLSGROVE DRIVE, ROCKVILLE, MD, 20850, US

(21) Appl. No.: 11/682,460

(22) Filed: Mar. 6, 2007

(30) Foreign Application Priority Data
Apr. 4, 2006 (TW) 95111920

(51) Int. Cl. G06F 9/44

(52) U.S. Cl. 712/225

(57) ABSTRACT

An apparatus and method of providing flexible load and store for multimedia applications are provided by the present invention, which comprising a register file, a load and store unit, a memory, a selective maskable permutable and collector load module (SMPCKM), and a control unit. The load and store unit includes a selective permutable and scatter store module (SPSSM), which can perform selective, permutable, and scatter store operation. Driving control signals by the control unit to control the operation state. With the present invention, permuting data could be efficient. The source data could be permuted arbitrarily with different operation modes according to the load and store characteristic, and then stored the source data to destination location. Moreover, the use of the load and store unit can reduce burden of performing permutable operation which needs extra instructions, such that performance can be enhanced.

### BACKGROUND OF THE INVENTION

1. Field of the Invention

The present invention relates to an apparatus and method of improving performance for multimedia applications and, more particularly, to an apparatus and method of providing flexible load and store for multimedia applications.

2. Description of Related Art

Conventionally, multimedia applications require a great deal of computations and guarantee finishing executing before time constraint such that real-time requirements must be achieved. The Discrete Cosine Transform (DCT), Inverse Discrete Cosine Transform (IDCT), Motion Compensation (MC), and Motion Estimation (ME) have wide applications in image, video compression and video coding. Single instruction multiple data (SIMD) is well known in multimedia application.

Load and store operation is used to load and store data from memory/register to register/memory. However, in some circumstance, memory access will be somewhat critical, such as DCT, IDCT. In these functional blocks, memory addresses of data will have special relationships. It needs to precede the step of displacement operation before permutable operation by using traditional load and store instructions. This technique has instructions to achieve displacement operation, lower the system performance and increase the permutable load.

The present invention aims to propose an apparatus and method of providing flexible load and store for multimedia applications to solve the above problems in the prior art.

### SUMMARY OF THE INVENTION

The primary objective of the present invention is to provide an apparatus and method of providing flexible load and store for multimedia applications to make memory load and store in single instruction multiple data (SIMD) architecture more flexible, and simplifies displacement operations which perform permutable data ability by loading and storing different operations such as “selective”, “maskable”, “permutable”, and “scatter or collector” load and store instruction.

Another objective of the present invention is to provide an apparatus and method of providing flexible load and store for multimedia applications, which provides a load and store unit to execute address operation, in the load and store unit further comprises a selective permutable scatter store module (SPSSM) to provide selective, permutable, and scatter store operation that data can store into memory in a specific order.

Yet another objective of the present invention is to provide an apparatus and method of providing flexible load and store for multimedia applications to which provides a selective maskable permutable collector load module (SMPCLM) to execute selective, maskable, permutable, and collector load operations, and so that data stored into memory can be arranged in a specified order such that computations on the data are more efficient on next reuse.

Yet another objective of the present invention is to provide an apparatus and method of providing flexible load and store for multimedia applications, which can be used in conventional 32-bit architecture, 64-bit and even its multiple bits architecture.

To achieve the aforementioned objectives, the present invention provides an apparatus and method of providing flexible load and store for multimedia applications, which provides at least two source operands and a destination operand in a register file to receive write back data. Driving several control signals by a control unit to control the operate state of a selective permutable and scatter store module (SPSSM) and a selective maskable permutable and collector load module (SMPCLM), and execute load and store operation, wherein the selective permutable and scatter store module is in a load and store unit. Transferring the source operand to the load and store unit and getting a memory address after processing, and store the destination operand at the memory address according to different operation states. Getting loading data from a memory and utilizing the selective maskable permutable and collector load module are achieved by executing selective or maskable, permutable and collector operation. Outputting data that have been selected or masked, permuted and collected to the register file.

### BRIEF DESCRIPTION OF THE DRAWINGS

The various objects and advantages of the present invention will be more readily understood from the following detailed description when read in conjunction with the appended drawing, in which:

FIG. 1 is a schematic block diagram of the apparatus of providing flexible load and store for multimedia applications provided by the present invention;

FIG. 2 is a schematic block diagram of the selective permutable and scatter store module (SPSSM) provided by the present invention;

FIG. 3 is a schematic block diagram of the selective maskable permutable and collector load module (SMPCLM) provided by the present invention;

FIG. 4 is an example of maskable loading half word data value to register file;

FIG. 5 is an example of selective storing half word data value to memory;

FIG. 6 is an example of selective storing one byte data value to memory;

FIG. 7 is an example of permutable load and store operations;

FIG. 8 is an example of collector operation; and

FIG. 9 is an example of scatter operation.

### DETAILED DESCRIPTION OF THE PREFERRED EMBODIMENTS

The present invention provides an apparatus and method of providing flexible load and store for multimedia applications, which uses for multimedia applications can make data load and store between memory and register more flexible with this apparatus, and the method for increasing efficient

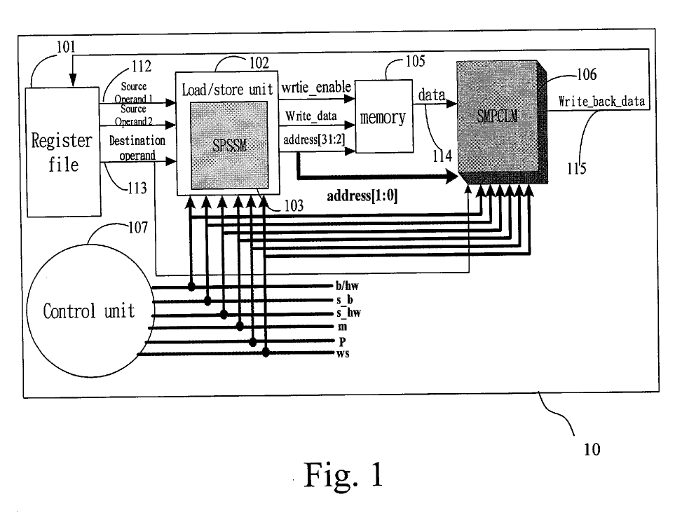

As shown in FIG. 1, the apparatus of providing flexible load and store for multimedia applications 10 comprises a register file 101, which outputs at least two source operands 112 and a destination operand 113 and receives write back data 115; a load and store unit 102 receives the source operand 112, and does selective, permutable and scatter store operations of the destination operand 113 by a selective permutable and scatter store module (SPSSM) which is in the load and store unit 102, and then store it in an address[31:2] of a memory 105 which computed according to the two source operand 112; a selective maskable permutable and collector load module (SMPCLM) 106, which can execute selective or maskable, permutable and collector operation to the memory data 114 of memory 105 with load operation, and writes back the data to the register file 101; and a control unit 107, which can drive control signals such as b/hw, s_b, s_hw, m, P, ws and S to control states of the SPSSM 103 and the SMPCLM 106.

For load operation, the load and store unit 102 sends the address to the memory 105. For store operation, the address[31:2] is sent to the memory 105 and the destination operand 112 sent from the register file 101 is placed to the memory 105 location specified by the address. If it is a selective, permutable, and scatter store operation, the SPSSM 103 will perform selective, permutable, and scatter store operation, and the result from SPSSM 103 will be stored to the memory 105. If it is a selective maskable, permutable, and collector load operation, the SMPCLM 106 will perform selective maskable, permutable, and collector operation on the data fetched from the memory 105 and store the result to the register file 101.

While performing selective or maskable operation, due to the provided load and store instructions are capable of operating on byte and half word, such that a signal of b/hw is used to determine the operation is on half word or just byte. If b/hw is 1, then the operation performed by this customized load and store instruction is half word, such that if it is 0, the operation is on byte. The signals of s_b and s_hw are two-bit and one-bit signals, which are used to determine the location of register value. If the register value is the destination data 113 that is putted to the memory 105 during store operation, determine byte or half word of this data from the register file 101 will be placed into memory 105. On the other hand, if the register value is the memory data 114 loaded from memory 105 and operated by the SMPCLM 106, then they are used to determine the memory data 114 should be placed in which byte or half word of the register value (write back data 115). The “m”-bit 111 are used to determine maskable operation, such that the remaining part of the data 115 can be determined to be reserved without any change. The two-bit address[1:0] determines which byte or half word need to be computed. For example, if b/hw is 0, s_b is 10, address[1:0] is 01, and it is store operation, then the second byte of the memory data 114 read from memory 105 will be placed into the third byte of the write back data 115.

P signal is 8-bit control signal of each 2-bit. While performing permutable operation, the P signal is used to determine permutations on the 4-byte data. For example, if P signal is 10,00,01,11, then the 4-th byte of the data is replaced with the third byte of the data, the third byte is replaced with the first byte, the second byte is replaced with the second byte and the first byte is replaced with the 4-th byte. The P signal is not necessary specified in the customized load and store instruction. However, the P signal can be placed in a special register (not shown in figures) and the register value is set up first before performing permutable operation.

While performing scatter or collector operation, an offset value must be specified. For example, if the offset value is 16-bit, then 4-byte data will be scattered such that each pair of byte is 8-bit apart. However, an arbitrary offset value is meaningless. For example, an offset value of 13-bit is meaningless. Consequently, three modes are applied in the scatter or collector operation, such that a ws bit of 3-bit is used to determine the three modes.

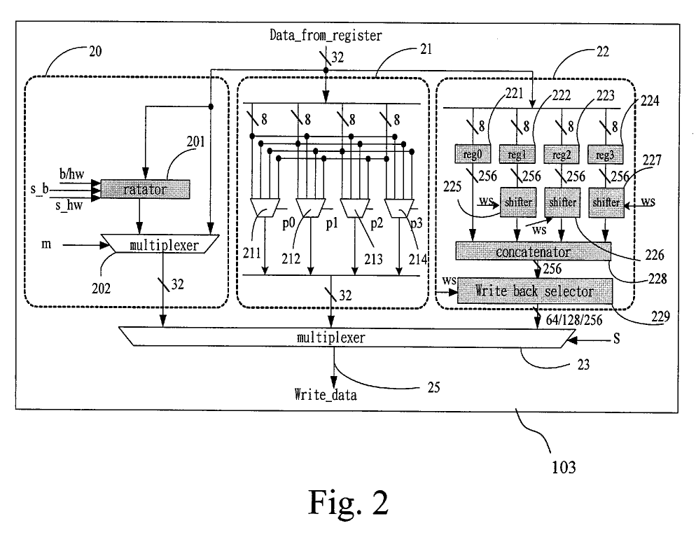

FIG. 2 is shown of the SPSSM 103, wherein includes a multiplexer 23 and three modules such as selective module 20, permutable module 21, and scatter module 22. The destination operand 113 in register file 101 sent into each module to compute. After computing, the three modules output the computation data to the multiplexer 23. Utilizing S bit to control for selecting the data 25 which will write back to memory 105.

There are a rotate 201 and a multiplexer 202 in the selective module 20. The rotator 201 performs rotate operation according to the b/hw, s_b, and s_hw bits. It is used to rotate destination operand 113 from the register file 101 before being stored into the memory 105 such that the four bytes of the data would be permuted at the proper positions. If a byte is wanted to store, then the s_b bit is used to determine which byte must be stored. If a half word is stored, then the s_hw bit is used to determine which half word should be stored. Note that the determination of using s_b or s_hw is according to the control signal of b/hw. The maskable operation is redundant in the store operation due to using the last two bits of address[1:0] as write enable signal to determine operand 113 should be stored into which byte or half word of the memory 105, such that the multiplexer 202 that can be controlled by the m bit is capable of using to select the result that is from the output of the rotator 201 or the register file 101.

With permutable module 21, the destination operand 113 from register file 101 is divided into four 1-byte data, and directly goes through four multiplexers 211, 212, 213, 214 for permutations. Each multiplexer is controlled by signals p0, p1, p2, and p3, and the four 2-bit p signals p0, p1, p2, p3 incorporates the 8-bit P signal. According to the P signal, each output of the multiplexer 211, 212, 213, 214 can be selected from arbitrary source of the destination operand 113 such that permutable operation is performed. Finally, each output of the multiplexer 211, 212, 213, 214 is recombined to the 32-bit data.

With scatter operation in the scatter module 22, each byte of the destination operand 113 must be an offset value apart. Moreover, due to performance consideration, the scatter operation must be performed in a cycle such that three shifters 225, 226, 227 are used to achieve the objective. Once scatter module 22 receives the destination operand 113 from the register file 101, then the 32-bit destination operand 113 is divided into four 8-bit data and each byte is placed in a temporary register 221, 222, 223, 224. The four registers 221, 222, 223, 224 are 256-bit and each byte of the destination operand 113 is placed in the most significant byte of the registers 221, 222, 223, 224. The reason that only three shifters 225, 226, 227 are needed is due to the first byte is not necessary to shift. A concatenator 228 then concatenates the four 256-bit data such that each 4-byte is specified offset value apart. The output of the concatenator 228 is driven to a write back selector 229, which used to write different size of data into the memory 105.

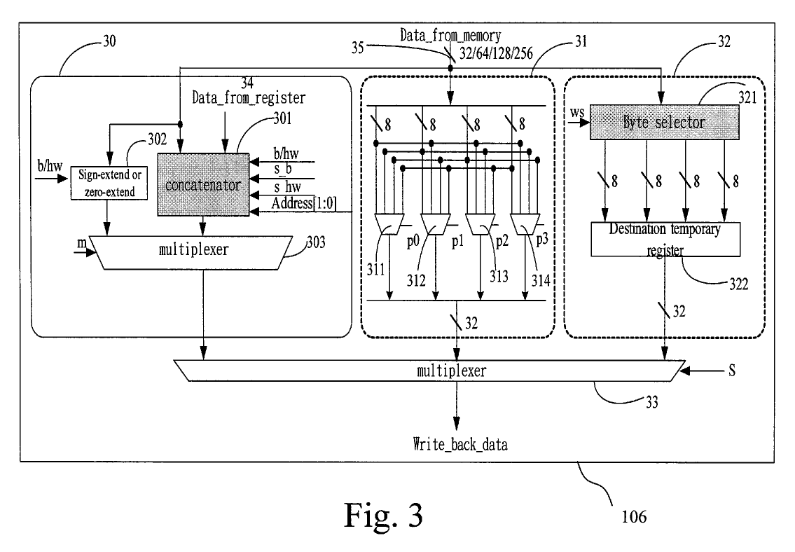

FIG. 3 is shown of SMPCLM 106, wherein includes a multiplexer 33 and three modules such as selective maskable module 30, permutable module 31, and collector module 32 to perform selective maskable, permutable, and collector load operation, and then outputs data to the multiplexer 23. The S bit is used to control which one of the outputs of the selective maskable module 30, permutable module 31, and collector module 32 three modules is the data 25 written back to the register file 101.

While performing the selective maskable load operation, the implementation is a little difference from the selective store operation. In the selective store operation, a rotator is used; however, in the selective maskable load operation, a concatenator 301 is used to accomplish the objective. The concatenator 301 is used to concatenate the data 35 from memory 105 and the data 34 from register file 101 according to s_b, s_hw, b/hw bits and address[0:1]. The reason that the data 35 from register file 101 (112 in FIG. 1) is used is due to the remaining part of the data must be reserved without any change if maskable operation is applied. The signed-extend or zero-extend module 302 is capable of performing extension on the remaining part of data according to the b/hw signal. For example, if a half word is loaded, then the data is signed-extend or zero-extend to a word. Outputs of the concatenator 301 and the signed-extend or zero-extend module 302 passed through the multiplexer 303 for selecting one of the outputs to be the sources of write back data.

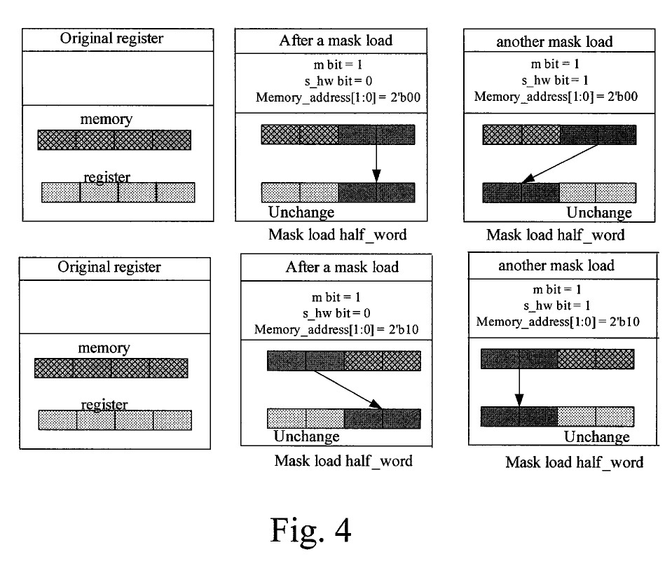

With permutable operation, the operation of the permutable module 31 is the same as the module 21 described in FIG. 2. Therefore, four multiplexers 311, 312, 313, 314 and four 2-bit signals p0, p1, p2, p3 are used to re-permute the memory data 35. With collector operation, four bytes that are an offset apart must be collected such that a wider fetch bandwidth must be used. However, due to fixed length fetch bandwidth, several cycles are needed to fetch the required data 35. Therefore, the byte selector module 321 includes a load buffer (not shown in figures) is needed to store the incoming data. With the scatter or collector operation, three modes are supported, and one is a 16-bit offset, another is a 32-bit offset, and the other is a 64-bit offset. The ws bit is used to select which mode is now used. According to the ws bit, the byte selector 321 drives the required four bytes from the load buffer, and outputs the four bytes to a destination temporary register 322. Finally the multiplexer 33 selects the outputs of the selective maskable module 30, permutable module 31, and collector module 32 according to the S bit 34 which is driven by the control unit 107. FIG. 4 depicts two examples of sequential maskable loading of two half word data values. If m bit is 1, s_hw bit is 0 and address[1:0] is 00, then lower half word of the data that from memory would be loaded into lower half word of the register and upper half word of the register would be reserved without zero-extend, sign-extend or any change. In other words, upper half word of the data is masked. If m bit is 1, s_hw bit is 1 and address[1:0] is 00, then lower half word of the register would be reserved without zero-extend, sign-extend or any change and lower half word of the data would be loaded into upper half word of the register. As illustrated in another example, if m bit is 1, s_hw bit is 0 and address[1:0] is 10, then upper half word of the data from memory would be loaded into lower half word of the register, and upper half word of the data would be reserved without zero-extend, sign-extend or any change. If m bit is 1, s_hw bit is 1 and address[1:0] is 10, then upper half word of the data from memory would be loaded into upper half word of the register, and lower word of the register would be reserved without zero-extend, sign-extend or any change.

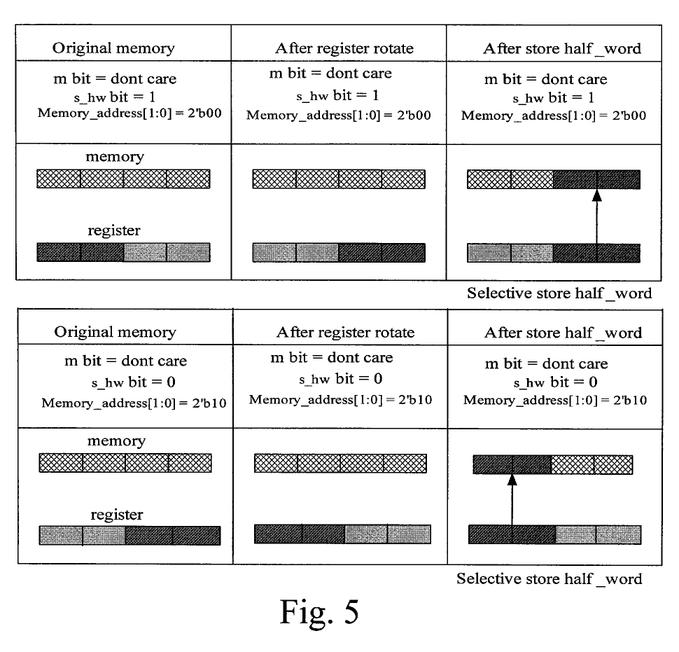

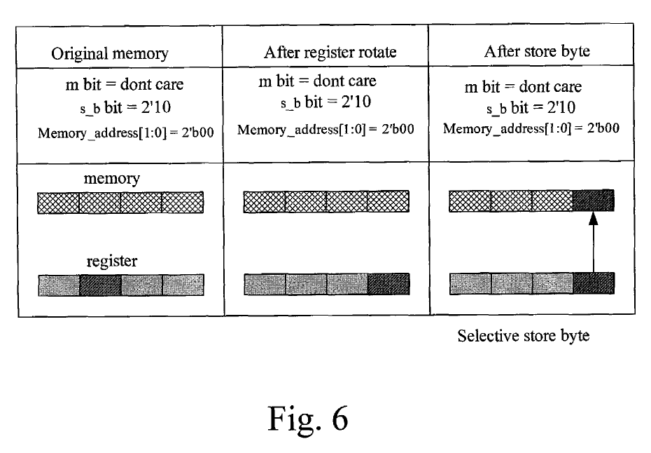

FIG. 5 and FIG. 6 depict examples of selective storing a half word and a byte data to memory. In FIG. 5, the 1-bit s_hw is 1 and needed to rotate right the upper half word of the register and then it is stored to the lower half word of the memory. If the s_hw bit is 0, then the lower half word of the register is rotate to the upper half word and it is stored to the upper half word of the memory. In FIG. 6, the 2-bit s_b is used to rotate the third byte of the register and it is stored to the first byte of the memory.

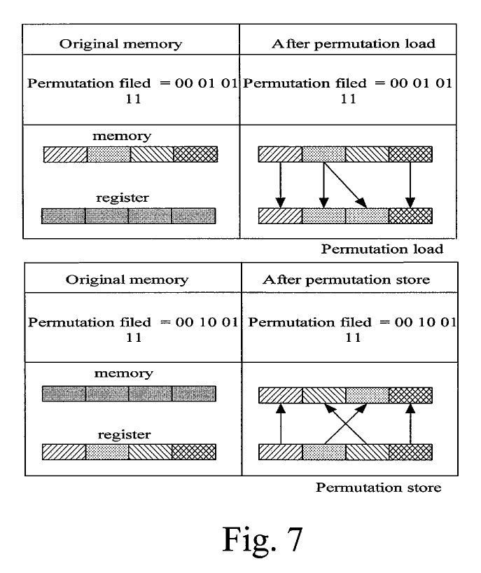

FIG. 7 depicts examples of permutable load and store operations. As shown in the figure, the P bit is 00, 01, 01, 11, and after permutation, the data from memory is rearranged. The 4-th byte is unchanged; the third byte and the second byte are replaced with the third byte of the fetched memory data, and the first byte is unchanged. In the permutable operation, if the P bit is 00, 10, 01, 11, the second byte and the third byte of the stored data is replaced with the third byte and the second byte of the register data.

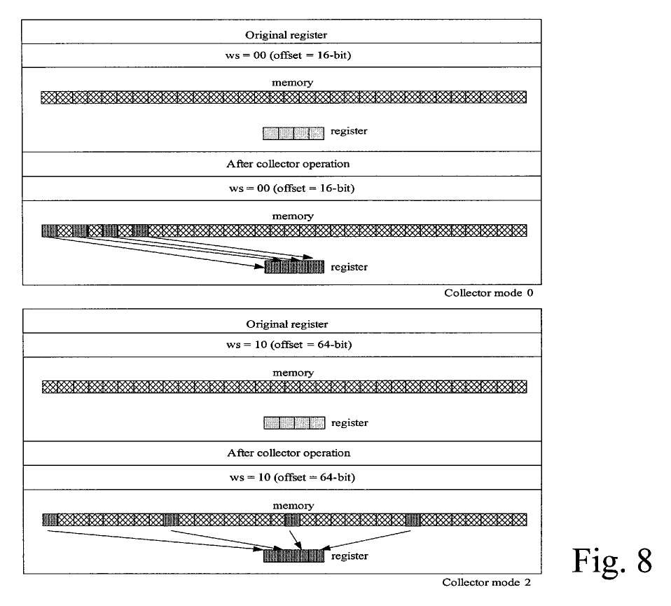

FIG. 8 illustrates collector operation. The ws bit is 00, such that a 16-bit offset is specified, and thus four bytes that are 8-bit apart are fetched to form a 32-bit data. When ws bit is 10, a 64-bit offset is used. With the offset value, four bytes that are 56-bit apart are fetched to form a 32-bit data.

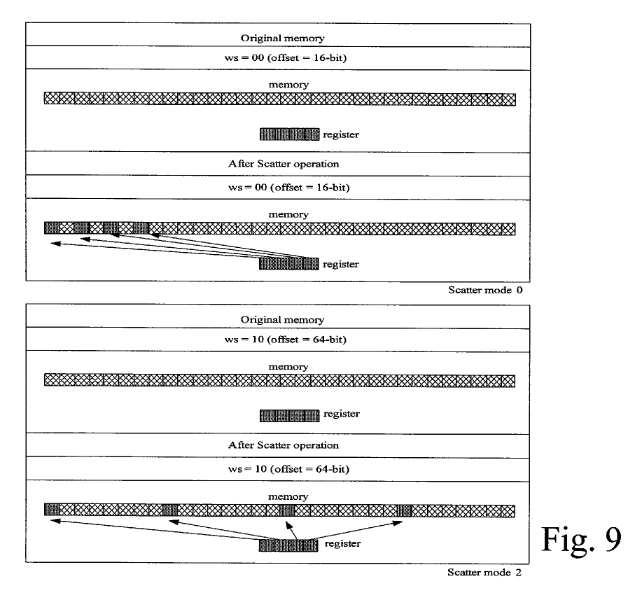

FIG. 9 illustrates scatter operation. In the first example, the ws bit is 00, such that a 16-bit offset is specified. With this 16-bit offset value, the four bytes from register file are placed in the four locations of the temporary register that each location is 8-bit apart. In the second example, the ws bit is 10, such that a 64-bit offset is used. With the offset value, the four bytes from register file are placed in the four locations of the temporary register that each location is 56-bit apart.

The present invention provides an apparatus and method of providing flexible load and store for multimedia applications, which utilize two modules such as a SPSSM and a SMPCLM to permute data flexibly without extra instructions. It can reduce operation of shifting for permute data in the prior art, and further can promote the system efficient.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method of providing flexible load and store for multimedia application, which moves data between a memory and a register by load and store modules, the method comprise the step of:
providing at least two source operand and a destination operand in a register file, which receives write back data;
driving several control signals by a control unit to control operate state of a selective permutable and scatter store module (SPSSM) and a selective maskable permutable and collector load module (SMPCLM), and execute load and store operation, wherein said selective permutable and scatter store module is in a load and store unit;
transferring said source operand to said load and store unit and getting a memory address after processing, and store said destination operand at said memory address according to different operation states;
getting loading data from a memory, and utilizing said selective maskable permutable and collector load module to execute selective or maskable, permutable and collector operation; and
outputting data that have been selected or masked, permuted and collected to said register file.

2. The method of providing flexible load and store for multimedia application as claimed in claim 1, wherein said control unit determines the operation state is selective, permutable and scatter store operation, said SPSSM executes the selective, permutable and scatter store operation and stores result of the store operation into said memory.

3. The method of providing flexible load and store for multimedia application as claimed in claim 1, wherein said control unit determines the operation state is maskable/permutable/collector load operation, said SMPCLM executes the maskable/permutable/collector load operation of data from said memory and stores the result of the operation into said register file.

4. The method of providing flexible load and store for multimedia application as claimed in claim 1, wherein said SPSSM further comprises a selective store module, a permutable module, and a scatter module, and said control unit send out a control signal to choose using which of the modules for operating.

5. The method of providing flexible load and store for multimedia application as claimed in claim 4, wherein said selective store module comprises a rotator and a multiplexer.

6. The method of providing flexible load and store for multimedia application as claimed in claim 4, wherein said permutable module comprises several multiplexers.

7. The method of providing flexible load and store for multimedia application as claimed in claim 4, wherein said scatter store module comprises four temporary registers, three shifters, a concatenator, and a write back selector, that said temporary registers and said shifter transmit signals through said concatenator to said write back selector.

8. The method of providing flexible load and store for multimedia application as claimed in claim 5, wherein said rotator is used to rotate right data which is from said register file such that needed byte or half word of the data is permuted at proper positions.

9. The method of providing flexible load and store for multimedia application as claimed in claim 5, wherein said multiplexer is used to select the data that is from output of said rotator or said register file.

10. The method of providing flexible load and store for multimedia application as claimed in claim 4, wherein said load and store module includes a multiplexer for selecting three outputs of the three modules of said SPSSM.

11. The method of providing flexible load and store for multimedia application as claimed in claim 6, wherein incoming data of said permutable module is divided into four bytes and said four bytes is driven to four said multiplexers for permutation.

12. The method of providing flexible load and store for multimedia application as claimed in claim 11, wherein said control signal controls said four multiplexers, and said control signal is specified in customized instruction or placed in a special register.

13. The method of providing flexible load and store for multimedia application as claimed in claim 1, wherein said SPSSM with selective operation, arbitrary part of the data which is selected to be placed into the arbitrary part of any memory location.

14. The method of providing flexible load and store for multimedia application as claimed in claim 1, wherein said SPSSM with permutable operation, four bytes of said source operand are loaded into said destination operand in an arbitrary order.

15. The method of providing flexible load and store for multimedia application as claimed in claim 1, wherein said SPSSM with scatter operation, four bytes of said source operand are stored into said memory by a specified offset.

16. The method of providing flexible load and store for multimedia application as claimed in claim 13, wherein said selective store operation has two categories of store operations, one is selective store half word and the other is selective store byte.

17. The method of providing flexible load and store for multimedia application as claimed in claim 15, wherein said scatter operation has several kinds of modes, and each mode specifies an offset value.

18. The method of providing flexible load and store for multimedia application as claimed in claim 7, wherein data incoming into said scatter store module is divided into four bytes and each byte is placed in each temporary register, and said three shifters perform different number of right shift operations according to said control signal, then three outputs of each said three shifters and output of 4-th temporary in said four registers are driven to said concatenator.

19. The method of providing flexible load and store for multimedia application as claimed in claim 18, wherein said concatenator concatenates four incoming data such that each byte is an offset value apart and said concatenator outputs result to said write back selector.

20. The method of providing flexible load and store for multimedia application as claimed in claim 7, wherein said write back selector writes back useful portion of scattered data to said register file.

21. The method of providing flexible load and store for multimedia application as claimed in claim 1, wherein said SMPCLM further incorporates a multiplexer and three modules, selective maskable store module, permutable module, and collector store module, wherein said multiplexer is used to select three outputs of said three modules.

22. The method of providing flexible load and store for multimedia application as claimed in claim 21, wherein said permutable module includes several multiplexers.

23. The method of providing flexible load and store for multimedia application as claimed in claim 22, wherein data incoming into said permutable module is divided into four bytes and the four bytes is driven to four multiplexers for permutations.

24. The method of providing flexible load and store for multimedia application as claimed in claim 23, wherein said four multiplexers are controlled by said control signal, and said control signal is specified in customized instruction or placed in a special register.

25. The method of providing flexible load and store for multimedia application as claimed in claim 21, wherein said collector store module incorporates a byte selector and a temporary register.

26. The method of providing flexible load and store for multimedia application as claimed in claim 25, wherein said byte selector selects four bytes that is an offset value apart according to said control signal, and places said four bytes into said temporary register.

27. The method of providing flexible load and store for multimedia application as claimed in claim 1, wherein said SMPCLM with selective operation, arbitrary part of the data which is from said memory is selected to be loaded into arbitrary part of said register.

28. The method of providing flexible load and store for multimedia application as claimed in claim 1, wherein said SMPLCM with maskable operation, if only part of the data is loaded into said register file, then remaining part of the data is determined to be reserved without zero-extend, sign-extend, or any change.

29. The method of providing flexible load and store for multimedia application as claimed in claim 1, wherein said SMPLCM with permutable operation, four bytes of the source operand are loaded into said destination operand in an arbitrary order.

30. The method of providing flexible load and store for multimedia application as claimed in claim 1, wherein said SMPLCM with collector operation, four non-adjacent bytes by an alternate offset of the data are loaded into said register file.

31. The method of providing flexible load and store for multimedia application as claimed in claim 21, wherein said selective maskable load module has two categories of load operations, one is selective maskable load half word and the other is selective maskable load byte.

32. The method of providing flexible load and store for multimedia application as claimed in claim 21, wherein said selective maskable load module includes a concatenator, a sign-extend or zero-extend module, and a multiplexer, and after data transferring from said memory to said SMPLCM, said concatenator and said sign-extend or zero-extend module receive said data and then transfer it to said multiplexer for processing.

33. The method of providing flexible load and store for multimedia application as claimed in claim 32, wherein said concatenator is used to concatenate the data from said memory and the data from said register file according to said control signals that cause needed byte or half word is placed in proper location of said register file and remaining part is reserved without any change.

34. The method of providing flexible load and store for multimedia application as claimed in claim 32, wherein said signed-extend or zero-extend module is capable of performing signed-extension, and zero-extension, wherein if maskable operation is disable, the signed-extend or zero-extend module is capable of performing extension on remaining part of the data such that said multiplexer is capable of selecting the write back data that is from output of said concatenator or said signed-extend or zero-extend module.

35. The method of providing flexible load and store for multimedia application as claimed in claim 30, wherein said collector operation has several kinds of modes, and each mode specifies an offset value.

36. The method of providing flexible load and store for multimedia application as claimed in claim 1, which used not only in conventional 32-bit architecture, but also used in 64-bit and even larger architecture.

37. An apparatus of providing flexible load and store for multimedia application, which comprising:
a register file, which provides at least two source operand and a destination operand and receives write back data;
a load and store unit, which includes a selective permutable and scatter store module (SPSSM) to execute select, permute and scatter store operation and operate address of said source operand which received by said load and store unit, then output a address;
a memory, which receives said address with load operation, and puts said destination operand at location of said address with store operation;
a selective maskable permutable and collector load module (SMPCLM), which execute selective or maskable, permutable and collector operation with load operation and writes back the data to said register file; and
a control unit, which drive control signals to control states of said SPSSM and said SMPCLM, and determine information of said control signals to be coding load and store form by themselves.

38. The apparatus of providing flexible load and store for multimedia application as claimed in claim 37, wherein said control unit determines operation state is selective, permutable, and scatter store operation, said SPSSM executes the selective, permutable, and scatter store operation and stores result of the store operation into said memory.

39. The apparatus of providing flexible load and store for multimedia application as claimed in claim 37, wherein said control unit determines the operation state is maskable, permutable, and collector load operation, said SMPCLM executes the maskable, permutable, and collector load operation of data from said memory and stores result of the load operation into said register file.

40. The apparatus of providing flexible load and store for multimedia application as claimed in claim 37, wherein said SPSSM further comprise a selective store module, a permutable module, and a scatter module, each for selecting, permuting, and scattering operations.

41. The apparatus of providing flexible load and store for multimedia application as claimed in claim 40, wherein said elective store module comprises a rotator and a multiplexer.

42. The apparatus of providing flexible load and store for multimedia application as claimed in claim 40, wherein said permutable module comprises several multiplexers.

43. The apparatus of providing flexible load and store for multimedia application as claimed in claim 40, wherein said scatter store module comprises four temporary registers, three shifters, a concatenator, and a write back selector, that said temporary registers and said shifters transmit signals through said concatenator to said write back selector.

44. The apparatus of providing flexible load and store for multimedia application as claimed in claim 40, wherein said load and store module includes a multiplexer for selecting three outputs of each said three modules of said SPSSM.

45. The apparatus of providing flexible load and store for multimedia application as claimed in claim 43, wherein data incoming into said scatter store module is divided into four bytes and each byte is placed in each temporary register, and said three shifters perform different number of right shift operations according to said control signal, then three outputs of said shifters and output of 4-th temporary in said register are driven to said concatenator.

46. The apparatus of providing flexible load and store for multimedia application as claimed in claim 45, wherein said concatenator concatenates four incoming data such that each byte is an offset value apart and said concatenator outputs result to said write back selector.

47. The apparatus of providing flexible load and store for multimedia application as claimed in claim 37, wherein said SMPCLM further incorporates a multiplexer and three modules, selective maskable store module, permutable module, and collector store module, wherein said multiplexer is used to select the three outputs of said three modules.

48. The apparatus of providing flexible load and store for multimedia application as claimed in claim 47, wherein said permutable module comprises several multiplexers.

49. The apparatus of providing flexible load and store for multimedia application as claimed in claim 48, wherein data incoming into said permutable module is divided into four bytes and the four bytes is driven to four multiplexers for permutations.

50. The apparatus of providing flexible load and store for multimedia application as claimed in claim 47, wherein said collector store module incorporates a byte selector and a temporary register.

51. The apparatus of providing flexible load and store for multimedia application as claimed in claim 50, wherein said byte selector selects four bytes that is an offset value apart according to said control signal, and places said four bytes into said temporary register.

52. The apparatus of providing flexible load and store for multimedia application as claimed in claim 47, wherein said selective maskable load module includes a concatenator, a sign-extend or zero-extend module, and a multiplexer, and after data transferring from said memory to said SMPLCM, said concatenator and said sign-extend or zero-extend module receive said data and then transfer it to said multiplexer for processing.

53. The apparatus of providing flexible load and store for multimedia application as claimed in claim 52, wherein said concatenator is used to concatenate said data transferring from said memory and data from said register file according to said control signals that cause needed byte or half word is placed in proper location of said register and remaining part is reserved without any change.
